(19) United States
(12) Patent Application Publication
(10) Pub. No.: US 2026/0176775 A1
(43) Pub. Date: Jun. 25, 2026

(54) Method for electrocatalytic synergistic treatment of industrial sulfur-containing flue gas and conversion of PET waste plastics into hydroxymethanesulfonate

(71) Applicant: Beijing University Of Technology, Beijing (CN)

(72) Inventors: Changlong Wang, Beijing (CN); Minwei Song, Beijing (CN); Yufeng Wu, Beijing (CN); Jiaqi Dang, Beijing (CN)

(21) Appl. No.: 19/406,945

(22) Filed: Dec. 3, 2025

(30) Foreign Application Priority Data
Dec. 19, 2024 (CN) 2024118830068

(51) Int. Cl. C25B 3/07; B01D 53/48; C25B 3/29; C25B 11/077

(52) U.S. Cl. CPC C25B 3/07; B01D 53/485; C25B 3/29; C25B 11/077

(57) ABSTRACT

The present invention relates to a method for electrocatalytically and synergistically treating industrial sulfur-containing flue gas and converting PET waste plastics into hydroxymethanesulfonate. The method includes: passing industrial sulfur-containing flue gas into an alkaline solution to obtain treatment solution, where the sulfur-containing flue gas contains sulfur-containing oxides; hydrolyzing waste PET plastics in an alkaline solution to obtain PET hydrolysate containing ethylene glycol; mixing the treatment solution and the PET hydrolysate to prepare an electrolyte, and through an electrolytic reaction, converting ethylene glycol in the PET hydrolysate and sulfur-containing oxides into hydroxymethanesulfonate. The present invention synergistically integrates the treatment of industrial sulfur-containing flue gas with the recycling of waste PET plastics, converting them into the high-value chemical, hydroxymethanesulfonate. This strategy not only enhances the recycling value of waste PET but also utilizes the by-products from the flue gas desulfurization process, enhances overall process efficiency and economic viability.

### CROSS-REFERENCE TO RELATED APPLICATIONS

This application also claims the priority benefit of Chinese Patent Application No. 202411883006.8, entitled “A method for electrocatalytic synergistic treatment of industrial sulfur-containing flue gas and conversion of PET waste plastics into hydroxymethanesulfonate”, filed with the China National Intellectual Property Administration on Dec. 19, 2024. The entirety of each of the above-mentioned patent applications is hereby incorporated by reference herein and made a part of this specification.

### BACKGROUND OF THE INVENTION

### 1. Technical Field

The present invention relates to the technical field of electrocatalytic technology, in particular to a method for electrocatalytically and synergistically treating industrial sulfur-containing flue gas and converting waste PET plastics into hydroxymethanesulfonate.

### 2. Background Art

In the process of non-ferrous smelting and processing, industrial flue gas is an inevitable by-product. Among them, industrial sulfur-containing flue gas is regarded as polluting exhaust gas, especially because it contains a large amount of sulfur-containing oxides. Sulfur dioxide is a typical sulfur oxide in it. As one of the main gases causing acid rain, it usually causes corrosion and damage to soil, water bodies, vegetation, and buildings if not disposed of safely. Therefore, the recovery of industrial sulfur-containing flue gas can not only effectively reduce environmental pollution in industrial production but also serve as an important way to achieve resource-based disposal of harmful gases.

In recent years, the disposal technologies for industrial sulfur-containing flue gas have mainly focused on desulfurization to meet emission standards, while converting the sulfur element in it into chemical substances such as sulfuric acid and sulfates. Wet absorption is one of the main technologies for flue gas desulfurization. Its main principle is to absorb SO₂ in the sulfur-containing flue gas through an alkaline solution to obtain a mixed solution containing sulfur-containing oxides.

Chinese Patent CN201711452293.7 discloses a method for preparing sulfuric acid from smelting flue gas. In this method, the sulfur-containing flue gas after deep purification is dried in dilute sulfuric acid. Then, the dried sulfur-containing flue gas is sent to a converter with a catalyst bed to convert sulfur dioxide in the flue gas into sulfur trioxide. Finally, the flue gas is passed into sulfuric acid to produce concentrated sulfuric acid. This method features a simple and easily operable process with broad applicability. However, its final product is relatively conventional, it has high requirements for equipment, and its economic value is limited.

Chinese Patent CN202311080318.0 discloses a method for separating and purifying fly ash pickling salts from sulfur-containing flue gas and resource utilization. In this method, the sulfur-containing flue gas is subjected to heat exchange and oxidation treatments and then introduced into the fly ash pickling salt solution. Subsequently, water-washed calcium sulfate and washing solution are obtained through separation, precipitation, and water-washing treatments. The washing solution is mixed with the mother liquor from the first step and then subjected to evaporation treatment to obtain a saturated salt solution and mixed salts. A sodium collector is added to the saturated salt solution and mixed salts for flotation, separation, filtration, washing, and reaction, ultimately yielding potassium sulfate and calcium chloride. This method produces high-value chemicals, but its process is cumbersome, requires a sodium collector, and results in low product purity and yield.

The disposal of waste PET plastics has always been a global concern. Traditional methods for waste PET plastic treatment, such as incineration and landfilling, occupy large amounts of land resources and cause serious harm to soil, water bodies, and the atmosphere. In recent years, electrocatalytic technology has gradually shown its potential in the reuse of waste PET plastics, enabling the conversion of waste PET plastics into terephthalic acid (PTA) and ethylene glycol (EG) monomers, with high efficiency and selectivity. The final products of this process are often formic acid and glycolic acid, which have certain economic benefits. However, the development of high-value products is the research trend in the electrocatalytic conversion of waste PET plastics.

Based on this, the present invention proposes a new method for the synergistic treatment of industrial sulfur-containing flue gas and waste PET plastics, aiming to achieve the safe disposal of solid waste and the short-process preparation of high-value chemicals. In this process, industrial sulfur-containing flue gas is first treated by wet absorption, and waste PET plastics are treated by alkaline hydrolysis. Then, electrocatalysis is used to couple sulfur-containing oxides with carbon atoms to form hydroxymethanesulfonate. As an important compound, hydroxymethanesulfonate is widely used as an intermediate in drug synthesis, playing a key role in the synthesis of drugs such as isoniazid sodium sulfonate and Yandi. Therefore, it occupies an important position in the pharmaceutical industry.

Guided by the green and sustainable development of the global economic society, the rational disposal of solid waste and industrial waste gas is crucial for building a green, low-carbon and circular development economic system. Based on this, the present invention not only combines the recycling of waste plastic PET with the treatment of industrial sulfur-containing flue gas, but also proposes a short-process method for preparing high-value chemicals. This method can effectively solve the environmental problems caused by industrial sulfur-containing flue gas and plastic waste, and also has high economic benefits, thus promoting the development of a circular economy.

### SUMMARY OF THE INVENTION

The objective of the present invention is to synergistically handle industrial sulfur-containing flue gas and recycle waste PET plastics. By combining the sulfur-containing flue gas and waste PET plastics, they are converted into high-value chemical hydroxymethanesulfonate. This achieves the goal of enhancing the recycling value of waste PET plastics, while fully utilizing the products from the industrial flue gas desulfurization process, and improving the recycling rate of waste and economic benefits.

To this end, the present invention proposes a method for electrocatalytically co-treating industrial sulfur-containing flue gas and PET waste plastics to convert them into hydroxymethanesulfonate.

The method comprises the following steps:
S1. Pass the industrial sulfur-containing flue gas with sulfur-containing oxides into an alkaline solution to obtain treatment solution.
S2. Hydrolyze waste PET plastics in an alkaline solution to obtain PET hydrolysate containing ethylene glycol.
S3. An electrolyte is prepared by mixing the treatment solution and the PET hydrolysis solution, and then, the electrolyte is subjected to an electrolytic reaction, which converts ethylene glycol and sulfur-containing oxides therein into hydroxymethanesulfonate.

Preferably, the industrial sulfur-containing flue gas in step S1 contains SO₂ gas, the alkali solution is a 0.1-4 mol/L NaOH or KOH solution, the flow rate of the sulfur-containing flue gas is 2-5 mL/s, and the introduction time is 10-60 min; the treatment solution contains sulfites.

Preferably, the hydrolysis conditions in step S2 are as follows: using a 2-6 mol/L NaOH or KOH solution, with a reaction temperature of 50-90° C., a stirring speed of 100-500 rpm, a reaction time of 6-24 hours, and a solid-to-liquid ratio of 1:5-1:20 (g/mL).

Preferably, the waste PET plastics in step S2 are one or more of waste PET powder, waste PET plastic blocks, or finished products processed from waste PET plastics.

Preferably, after the waste PET plastics in step S2 are hydrolyzed by an alkaline solution, the pH of the hydrolysate is adjusted to 2.8-3.0, and then a precipitated TPA is separated by solid-liquid separation from the hydrolysate containing ethylene glycol.

Preferably, the electrode system in step S3 consists of a working electrode, a counter electrode, and a reference electrode. The working electrode is a metal oxide or hydroxide loaded on carbon fiber paper or carbon cloth, the reference electrode is Ag/AgCl, and the counter electrode is a platinum mesh. The metal in the working electrode is selected from cobalt, nickel, manganese, copper, palladium or more than one of them.

Preferably, the electrolysis conditions in step S3 are constant voltage conditions, with a voltage of 1.20-1.35 V (vs. Ag/AgCl reference electrode) at room temperature.

Preferably, the electrolyte in step S3 includes 0.01-0.1 M sulfite and 0.1-1 M ethylene glycol.

Compared with the existing technologies, the present invention offers the following benefits:
(1) The present invention synergistically treats industrial sulfur-containing flue gas and waste PET plastics, and synthesizes hydroxymethanesulfonate through an electrocatalytic method. While producing high-value chemical products, it upgrades the traditional treatment process of industrial sulfur-containing flue gas, reasonably utilizes the waste solution generated during the desulfurization process, and prepares hydroxymethanesulfonate in a short process. The present invention simultaneously achieves the efficient treatment of sulfur-containing flue gas and the efficient recycling of waste PET plastics, with high economic benefits.
(2) The present invention obtains sulfites by collecting sulfur oxide gases rich in sulfur-containing flue gas with an alkaline solution. The waste PET plastics undergo a hydrolysis reaction under alkaline conditions to obtain PET hydrolysate containing ethylene glycol. The two alkaline solutions are combined and placed in an electrochemical synthesis system. Through an electrochemical method, electrocatalytic synthesis occurs between the sulfites and the ethylene glycol produced by the hydrolysis of PET, and a C-S coupling reaction is carried out to prepare hydroxymethanesulfonate.
(3) The present invention innovatively proposes a process method for the electrochemical synthesis of hydroxymethanesulfonate, which features high synthesis efficiency and selectivity, enabling the short-process preparation of hydroxymethanesulfonate with high yield. Meanwhile, the present invention suggests using specific metal oxides or metal hydroxides as catalysts to fabricate working electrodes and selecting appropriate acidic catalytic conditions to achieve efficient conversion and synthesis. In addition, compared with traditional hydroxymethanesulfonate manufacturing processes, the process and equipment of this invention are simpler, with high output value. It has higher economic and social values, shows potential for industrial production, and has broad application prospects.

### BRIEF DESCRIPTION OF THE DRAWINGS

FIG. 1 is a flowchart of the method of the present invention.

FIG. 2 is the SEM image of the manganese dioxide used in example 1.

FIG. 3 is the XRD pattern of manganese dioxide used in example 1.

FIG. 4 is the linear sweep voltammetry (LSV) curve test of the electrolytic system in example 1.

FIG. 5 is the ¹H NMR spectrum of the electrolytic reaction product in example

FIG. 6 is the ¹H NMR spectrum of the solution after hydrolysis in step S2 of example 4.

FIG. 7 is the linear sweep voltammetry (LSV) curve test of the electrolytic reaction in comparative example 1.

FIG. 8 is the test results of the yield of hydroxymethanesulfonate in comparative example 2.

### DETAILED DESCRIPTION OF THE INVENTION

The following describes the present invention in further detail through examples to illustrate the features and advantages of the present invention, without limiting the implementation modes of the present invention.

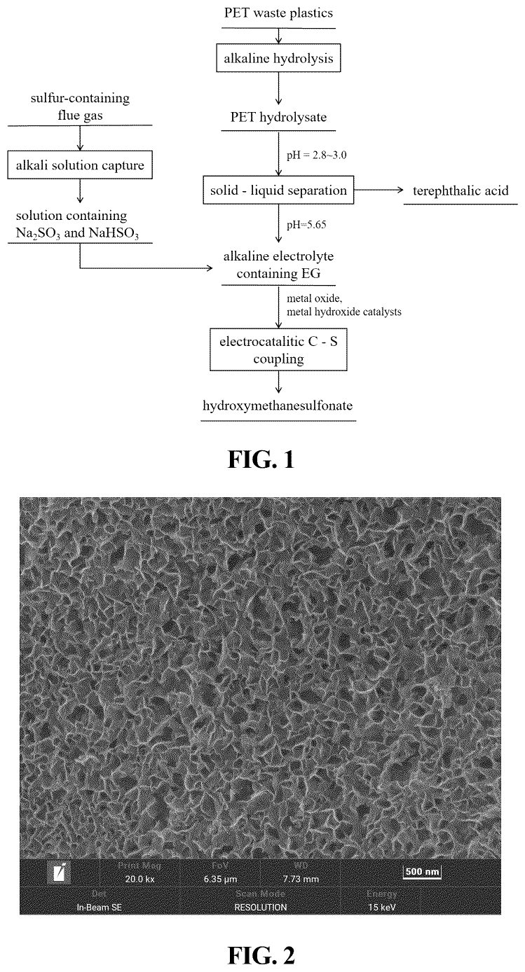

As shown in FIG. 1, the present invention proposes a method for the electrocatalytic co treatment of industrial sulfur-containing flue gas and PET waste plastics to convert them into hydroxymethanesulfonate, which includes the following steps:
S1. Pass industrial sulfur-containing flue gas, which contains sulfur-containing oxides, into an alkaline solution to obtain treatment solution.
S2. Hydrolyze waste PET plastics in an alkaline solution to obtain PET hydrolysate containing ethylene glycol.
S3. An electrolyte is prepared by mixing the treatment solution and the PET hydrolysis solution, and then, the electrolyte is subjected to an electrolytic reaction, which converts ethylene glycol and sulfur-containing oxides therein into hydroxymethanesulfonate.

In the method of the present invention, industrial sulfur-containing flue gas, which contains sulfur-containing oxides, is first introduced into an alkaline solution to obtain treatment solution. The waste PET plastics are hydrolyzed under alkaline conditions, and then the pH is adjusted to obtain a PET hydrolysate containing ethylene glycol. The PET hydrolysate is introduced into the treatment solution. After adjusting the pH, it is used as an electrolyte and electrolyzed in an electrode system to carry out a C-S coupling reaction, realizing the conversion of ethylene glycol in the alkaline PET hydrolysate to hydroxymethanesulfonate.

Therefore, the present invention combines the treatment of industrial sulfur-containing flue gas, the recycling process of waste PET plastics, and electrochemical methods to convert sulfur-containing flue gas and waste PET plastics into high-value chemical hydroxy methanesulfonate. This approach enhances the recycling value of waste PET plastics, makes full use of the products from the industrial flue gas desulfurization process, and improves the utilization rate of waste recycling and economic benefits.

In the present invention, the industrial sulfur-containing flue gas in step S1 contains SO₂ gas. The flue gas containing SO₂ mainly comes from the following types of combustion or industrial treatment processes: coal combustion, oil combustion, natural gas combustion, roasting of sulfur ores, production of carbon disulfide (CS₂), or production of sulfites (such as in the pulp bleaching process), etc.

Preferably, the alkaline solution is a 0.1-4 mol/L NaOH or KOH solution. The flow rate of the sulfur-containing flue gas is 2-5 mL/s, and the introduction time is 10-60 min. The formed treatment solution contains sulfite.

In the present invention, the main component of the waste PET plastics in step S2 is PET.

Preferably, the waste PET plastics in step S2 are one or more of waste PET powder, waste PET plastic blocks, or finished products processed from waste PET plastics. The finished products processed from waste PET plastics can be waste items such as packaging bottles, packaging boxes, and films. The finished products processed from waste PET plastics can be crushed to obtain PET powder or sheared to obtain waste PET plastic blocks.

Preferably, the hydrolysis conditions in step S2 are as follows: a 2-6 mol/L NaOH or KOH solution, a reaction temperature of 50-90° C., a stirring speed of 100-500 rpm, a reaction time of 6-24 hours, and a solid-to-liquid ratio of 1:5-1:20 (g/mL). The concentration of the alkaline solution and reaction conditions can be appropriately adjusted according to different waste PET plastics for the hydrolysis reaction. For example, for powdered PET plastics, within the optional parameter range of step S2, the hydrolysis reaction of PET can be achieved with a relatively low-concentration alkaline solution, a relatively low temperature, a relatively short reaction time, and a small amount of solution.

Preferably, after the waste PET plastics in step S2 are hydrolyzed by an alkaline solution, the hydrolyzate is adjusted to a pH of 2.8-3.0. After solid-liquid separation to obtain the precipitated TPA, an acidic hydrolyzate containing ethylene glycol is obtained.

Preferably, after mixing the treatment solution and the PET hydrolysate, further pH adjustment is required to convert the mixture into an acidic hydrolysate with the pH of 5.6-5.7, which is used for subsequent electrolytic reactions.

Preferably, in the method of the present invention, the acidic regulator in the pH adjustment step can be selected from sulfuric acid, hydrochloric acid etc.

Preferably, the electrolyte in step S3 includes 0.01-0.1 M sulfite and 0.1-1 M ethylene glycol.

To ensure the conductivity of the electrolyte, some electrolytes can be optionally added, such as common soluble conductive salts like sulfates and chlorides.

Preferably, the electrode system in step S3 consists of a working electrode, a counter electrode, and a reference electrode. The working electrode is a metal oxide or hydroxide loaded on carbon fiber paper or carbon cloth, the reference electrode is Ag/AgCl, and the counter electrode is a platinum mesh. The metal in the working electrode is selected from cobalt, nickel, manganese, copper, palladium or more than one of them.

Among them, carbon fiber paper or carbon cloth acts as a conductive carrier, which can stably support metal catalysts on its surface. Further, in order to achieve the effective loading of metal oxides or hydroxides, the carrier can be pre-treated by some conventional surface pre-treatment methods such as water washing, alcohol cleaning, acid washing, alkali washing or grinding.

Optionally, the metal oxides or hydroxides are supported on the carrier in the form of flakes or particles. More preferably, the metal oxides or hydroxides are in-situ deposited through chemical deposition and dispersed on the carrier in nanoscale to provide an active surface with a larger specific surface area and stronger adhesion.

To load the aforementioned metal oxides or hydroxides onto the carrier carbon fiber paper or carbon cloth, optional in-situ deposition methods can be employed, such as chemical deposition methods including liquid-phase deposition, liquid-phase deposition combined with high-temperature calcination, or chemical impregnation combined with high-temperature calcination.

Preferably, the metal oxides are cobalt oxide, nickel oxide, copper oxide, manganese oxide or palladium oxide; the metal hydroxides are preferably cobalt hydroxide, nickel hydroxide, copper hydroxide, manganese hydroxide or palladium hydroxide.

Preferably, the electrolysis conditions in step S3 are constant voltage conditions, with a voltage of 1.20-1.35 V (vs. Ag/AgCl reference electrode) at room temperature.

The following will specifically explain the method of the present invention in combination with specific implementation modes.

### Example 1

This example provides the following method for electrocatalytically and synergistically treating industrial sulfur-containing flue gas and converting PET waste plastics into hydroxymethanesulfonate, including:
S1. Pass industrial sulfur-containing flue gas, which contains sulfur-containing oxides, into an alkaline solution to obtain treatment solution.

Among them, the industrial sulfur-containing flue gas is the flue gas from the roasting of sulfide ores. The sulfur-containing oxides in the flue gas are SO₂ gases. The alkaline solution used for the capture of SO₂ gases includes a 0.1 mol/L NaOH solution. The flow rate of the sulfur-containing flue gas is 5 mL/s, and the introduction time is 30 min. The treatment solution is obtained, and the treatment solution contains sulfites.
S2. The waste PET plastics are hydrolyzed under alkaline conditions to obtain a PET hydrolysate containing ethylene glycol.

Among them, the waste PET plastic is 200-mesh waste PET powder. The alkaline solution for treating the waste PET plastic is a 4 mol/L NaOH solution. The reaction temperature is 70° C., the stirring speed is 300 rpm, the reaction time is 16 hours, and the solid-to-liquid ratio is 1:20.

After hydrolyzing waste PET plastics in an alkaline solution, the pH of the hydrolysate is adjusted to 2.8. After solid-liquid separation to obtain the precipitated TPA, an acidic hydrolysate containing ethylene glycol is obtained.
S3. An electrolyte is prepared by mixing the treatment solution and the PET hydrolysis solution, and then, the electrolyte is subjected to an electrolytic reaction, which converts ethylene glycol and sulfur-containing oxides therein into hydroxymethanesulfonate.

Among them, after mixing the treatment solution and the PET hydrolysate, further pH adjustment is required to prepare an acidic hydrolysate with a pH of 5.65 for the subsequent electrolytic reaction.

The electrolytic reaction employs a three-electrode system, which consists of a working electrode, a counter electrode, and a reference electrode. The working electrode is manganese dioxide loaded on carbon cloth, the reference electrode is Ag/AgCl, and the counter electrode is a platinum mesh.

The preparation method of the working electrode for the electrolysis reaction is as follows:
1) Preparation of the deposition solution: Weigh 0.01 g of potassium permanganate, 0.1 g of manganese sulfate, and 0.02 g of potassium persulfate, and dissolve them in 20 mL of deionized water. Stir the solution magnetically until complete dissolution. Adjust the pH of the solution to 8-11 (by adding dilute sulfuric acid or sodium hydroxide solution).
2) Chemical deposition: Immerse a 1 cm×1 cm carbon cloth in the deposition solution to ensure it is completely submerged. Place the deposition solution on a magnetic stirrer and stir at an appropriate speed while controlling the reaction temperature at 75° C. for 6 h. After the reaction is completed, take out the carbon cloth and rinse it with deionized water to remove the unreacted substances adhered to the surface.
3) Drying and calcination: Place the rinsed carbon cloth in an oven and dry it at 60° C. until a constant weight is achieved. Then, transfer it to a tube furnace and calcinate it at 300° C. for 2 h, followed by natural cooling. As a result, manganese dioxide supported on the carbon cloth is obtained.

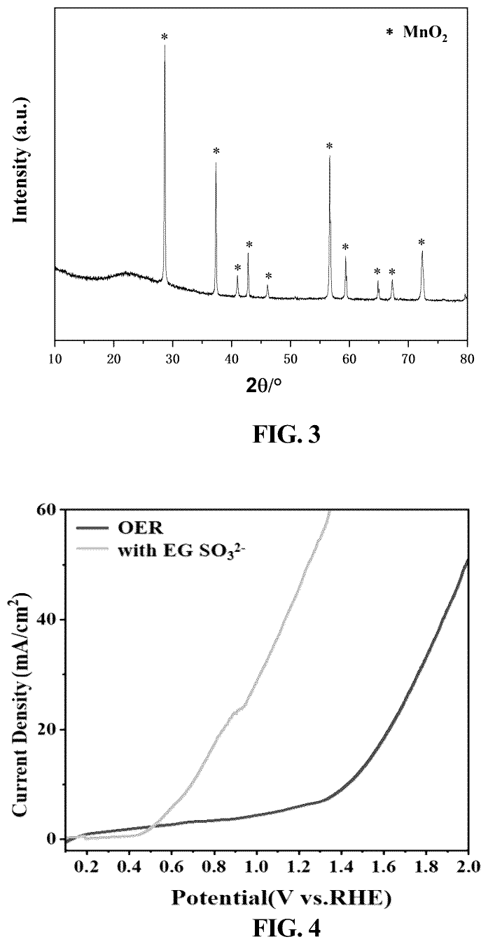

FIG. 2 shows the SEM image of manganese dioxide loaded on the carbon cloth. can be seen from the SEM image that the manganese dioxide exists in the form of nanosheets. FIG. 3 is the XRD pattern of the sediment scraped from the carbon cloth, which proves that it is manganese dioxide.

The electrolysis reaction was carried out at room temperature. The electrolyte used contained 0.1 M K₂SO₄, 20 mM Na₂SO₃, and 200 mM ethylene glycol. The voltage was 1.35 V vs. Ag/AgCl, and the reaction time was 240 min.

Analysis of the solution after the electrolytic reaction was completed revealed that the yield of hydroxymethanesulfonate obtained was 0.2 mol cm⁻² h⁻¹, and the purity of hydroxymethanesulfonate was 73%.

Among them: Yield=Number of moles of hydroxymethanesulfonate produced by the reaction/(Time*Reaction area of the working electrode (1 cm*1 cm));

Purity=Mass of hydroxymethanesulfonate in the product/(Mass of hydroxymethanesulfonate in the product+Mass of other impurities in the product)

As shown in FIG. 4, it is the linear sweep voltammetry (LSV) curve collected the electrolysis system of this example. It can be seen that the initial oxidation potential of the electrolysis system in this example is 0.425 V. The curve marked with the oxygen evolution reaction was obtained in an electrolyte containing only the same-concentration sulfite and no ethylene glycol, and the same electrode system as in Example 1 was used.

### Example 2

This example provides the following method for electrocatalytically and synergistically treating industrial sulfur-containing flue gas and converting PET waste plastics into hydroxymethanesulfonate, including:
S1. Pass the industrial sulfur-containing flue gas containing sulfur-containing oxides into an alkaline solution to obtain treatment solution.

Among them, the industrial sulfur-containing flue gas is the flue gas from the roasting of sulfide ores. The sulfur-containing oxides in the flue gas are SO₂ gases. The lye used for the capture of SO₂ gases includes 1 mol/L NaOH solution. The flow rates of the sulfur-containing flue gas are all 4 mL/s, and the injection time is 20 min, resulting in an aqueous solution containing sulfur-containing oxides.
S2. The waste PET plastics undergo hydrolysis reaction under alkaline conditions obtain the PET hydrolysate containing ethylene glycol.

Among them, the waste PET plastic is 200-mesh waste PET powder. The alkaline solution for treating the waste PET plastic is a 3 mol/L NaOH solution. The reaction temperature is 60° C., the stirring speed is 400 rpm, the reaction time is 18 hours, and the solid-to-liquid ratio is 1:10.

After hydrolyzing waste PET plastics in an alkaline solution, the pH of the hydrolysate is adjusted to 3.0. After solid-liquid separation to obtain the precipitated TPA, an acidic hydrolysate containing ethylene glycol is obtained.
S3. An electrolyte is prepared by mixing the treatment solution and the PET hydrolysis solution, and then, the electrolyte is subjected to an electrolytic reaction, which converts ethylene glycol and sulfur-containing oxides therein into hydroxymethanesulfonate.

Among them, after mixing the treatment solution and the PET hydrolysis solution, further pH adjustment treatment is required to adjust it into an acidic hydrolysis solution with a pH of 5.65 for the subsequent electrolytic reaction.

The electrolysis reaction employs a three-electrode system, which consists of a working electrode, a counter electrode, and a reference electrode. The working electrode is nickel hydroxide loaded on carbon cloth, the reference electrode is Ag/AgCl, and the counter electrode is a platinum mesh.

The preparation method of the working electrode used in the electrolytic reaction as follows:
1) Prepare the deposition solution: Dissolve 0.18 mmol of NiCl₂·6H₂O, 1 mmol o urea, and 0.8 mmol of NH₄F in 20 mL of deionized water and mix them.
2) Chemical deposition: Pour the deposition solution into a 10 mL autoclave containing a 1 cm×1 cm carbon cloth, seal the autoclave, then heat it to 180° C. and maintain this temperature for 6 hours. After the reaction is completed, take out the carbon cloth and rinse it with water and ethanol.
3) Drying: The carbon cloth was vacuum-dried at 60° C. for 4 hours to obtain nickel hydroxide supported on the carbon cloth.

The electrolytic reaction was carried out at room temperature. The electrolyte used contained 0.1 M K₂SO₄, 25 mM Na₂SO₃, and 250 mM ethylene glycol. The voltage was 1.3 V vs. Ag/AgCl, and the reaction time was 190 min.

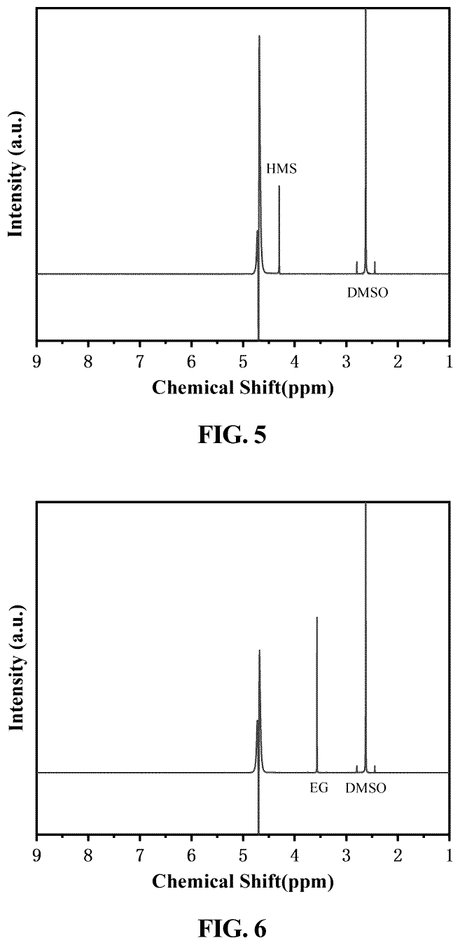

The electrolyte after electrocatalytic co-treatment in Example 2 was diluted and then subjected to nuclear magnetic resonance (NMR) testing. The results are shown in FIG. 5, which prove that the main product in the electrolyte is hydroxymethanesulfonate (HMS). Here, dimethyl sulfoxide (DMSO) is the solvent added for testing. Analysis of the solution after the electrolytic reaction was completed revealed that the yield of hydroxymethanesulfonate was 0.26 mol cm⁻² h⁻¹, and the purity of hydroxymethanesulfonate was 75%.

### Example 3

This example provides the following method for electrocatalytically co-treating industrial sulfur-containing flue gas and converting PET waste plastics into hydroxymethanesulfonate, including:
S1. Pass industrial sulfur-containing flue gas, which contains sulfur-containing oxides, into an alkaline solution to obtain treatment solution.

Among them, the industrial sulfur-containing flue gas is the flue gas from the roasting of sulfur-containing ores. The sulfur-containing oxides in the flue gas are SO₂ gases. The alkaline solution used for the capture of SO₂ gases includes a 2 mol/L NaOH solution. The flow rates of the sulfur-containing flue gas are all 3 mL/s, and the introduction time is 20 min, resulting in an aqueous solution containing sulfur-containing oxides.
S2. The waste PET plastics are hydrolyzed under alkaline conditions to obtain the PET hydrolysate containing ethylene glycol.

Among them, the waste PET plastic is 200-mesh waste PET powder.

Among them, the alkaline solution for treating waste PET plastics is a 2 mol/L NaOH solution. The reaction temperature is 80° C., the stirring speed is 300 rpm, the reaction time is 12 hours, and the solid-to-liquid ratio is 1:5.

After hydrolyzing waste PET plastics in an alkaline solution, the pH of the hydrolysate is adjusted to 2.9. After solid-liquid separation of the precipitated TPA, an acidic hydrolysate containing ethylene glycol is obtained.
S3. An electrolyte is prepared by mixing the treatment solution and the PET hydrolysis solution, and then, the electrolyte is subjected to an electrolytic reaction, which converts ethylene glycol and sulfur-containing oxides therein into hydroxymethanesulfonate.

Among them, after mixing the treatment solution and the PET hydrolysate, further pH adjustment is required to obtain an acidic hydrolysate with a pH of 5.65 for subsequent electrolysis reactions.

The electrolytic reaction employs a three-electrode system, which consists of a working electrode, a counter electrode, and a reference electrode. The working electrode is copper oxide loaded on carbon fiber paper, the reference electrode is Ag/AgCl, and the counter electrode is a platinum mesh.

The preparation method of the working electrode for the electrolytic reaction is as follows:
1) Prepare the deposition solution: Prepare 20 mL of 0.06 M copper nitrate solution.
2) Chemical deposition: Immerse the carbon fiber paper in a copper nitrate solution, maintain it at 50° C. in a constant-temperature water bath and stir for 24 hours to ensure that the copper nitrate is fully adsorbed on the surface of the carbon fiber paper. Take out the impregnated carbon fiber paper and rinse it thoroughly with deionized water to remove the unadsorbed copper nitrate on the surface. Place the carbon fiber paper loaded with copper nitrate in an oven and dry it at 60° C. to a constant weight.
3) Drying and calcination: Place the dried carbon fiber paper in a muffle furnace and calcine it at 400° C. for 4 hours to decompose copper nitrate and convert it into copper oxide. After the calcination is completed, take out the carbon fiber paper and put it into an oven again to dry at 60° C. until a constant weight is achieved. Copper oxide supported on carbon fiber paper is obtained.

The electrolysis reaction voltage was 1.25 V vs. Ag/AgCl. The electrolyte used contained 0.1 M K₂SO₄, 20 mM Na₂SO₃, and 200 mM ethylene glycol, and the reaction time was 300 min. After the electrolysis reaction was completed, the solution was analyzed. The yield of hydroxymethanesulfonate was 0.23 mol cm⁻² h⁻¹, and the purity of hydroxymethanesulfonate was 71%.

### Example 4

This example provides the following method for electrocatalytically and synergistically treating industrial sulfur-containing flue gas and converting PET waste plastics into hydroxymethanesulfonate, which includes:
S1. Pass the industrial sulfur-containing flue gas, which contains sulfur-containing oxides, into an alkaline solution to obtain treatment solution.

Among them, the industrial sulfur-containing flue gas is the flue gas from the roasting of sulfide ores. The sulfur-containing oxides in the flue gas are SO₂ gases. The alkaline solution used for the capture of SO₂ gases includes a 3 mol/L NaOH solution. The flow rates of the sulfur-containing flue gas are all 2 mL/s, and the introduction time is 50 min to obtain treatment solution, which contains sulfites.
S2. The waste PET plastics are hydrolyzed under alkaline conditions to obtain a PET hydrolysate containing ethylene glycol.

Among them, the waste PET plastic is 200-mesh waste PET powder. The alkaline solution for treating the waste PET plastic is a 5 mol/L NaOH solution. The reaction temperature is 50° C., the stirring speed is 500 rpm, the reaction time is 20 hours, and the solid-to-liquid ratio is 1:15.

The specific operation of pH adjustment treatment is as follows: After the waste PET plastics are hydrolyzed by an alkaline solution, the pH of the hydrolysate is adjusted to 3.0. After the precipitated TPA is separated by solid-liquid separation, an acidic hydrolysate containing ethylene glycol is obtained. The acidic hydrolysate with the pH adjusted to 5.65 is used for the subsequent electrolytic reaction. The PET alkaline hydrolysate is subjected to pH adjustment and separation and then undergoes nuclear magnetic detection. The results are shown in FIG. 6, which proves that the main substance in the solution after PET hydrolysis and separation is ethylene glycol (EG).
S3. An electrolyte is prepared by mixing the treatment solution and the PET hydrolysis solution, and then, the electrolyte is subjected to an electrolytic reaction, which converts ethylene glycol and sulfur-containing oxides therein into hydroxymethanesulfonate.

Among them, after mixing the treatment solution and the PET hydrolysate, further pH adjustment treatment is required to adjust the mixture into an acidic hydrolysate with a pH of 5.65 for the subsequent electrolytic reaction.

The electrolysis reaction employs a three-electrode system, which consists of a working electrode, a counter electrode, and a reference electrode. The working electrode is copper hydroxide loaded on carbon fiber paper, the reference electrode is Ag/AgCl, and the counter electrode is a platinum mesh.

The preparation method of the working electrode for the electrolytic reaction is as follows:
1) Prepare the deposition solution: Prepare a 20 mL solution containing 0.1 M copper sulfate and 0.2 M sodium hydroxide.
2) Chemical deposition: Immerse a 1 cm×1 cm carbon fiber paper into the copper sulfate deposition solution. Use magnetic stirring to ensure the uniform distribution of the solution on the surface of the carbon fiber paper and maintain this state for 30 minutes to ensure the full adsorption of copper ions. Take out the carbon fiber paper impregnated with copper sulfate, drain the excess solution, and then quickly immerse it into the sodium hydroxide solution. At this time, a precipitation reaction of copper hydroxide will occur on the surface of the carbon fiber paper. Keep it for 10 minutes and stir to promote the uniform progress of the reaction.
3) Drying: After the reaction is completed, take out the carbon fiber paper and rinse it thoroughly with deionized water to remove unreacted chemical substances and impurities on the surface. Place the carbon fiber paper loaded with copper hydroxide in an oven and dry it at 60° C. to a constant weight to remove excess moisture, obtaining copper hydroxide loaded on carbon fiber paper.

The voltage of the electrolytic reaction is 1.25 V vs. Ag/AgCl. The electrolyte used contains 0.1 M K₂SO₄, 25 mM Na₂SO₃, and 250 mM EG, and the reaction time is 200 min.

The solution after the reaction was tested, and the yield of hydroxymethanesulfonate was obtained as 0.29 mol cm⁻² h⁻¹, with a purity of 72%.

### Example 5

This example provides the following method for electrocatalytically co-treating industrial sulfur-containing flue gas and converting PET waste plastics into hydroxymethanesulfonate, including:
S1. Pass industrial sulfur-containing flue gas, which contains sulfur-containing oxides, into an alkaline solution to obtain treatment solution.

Among them, the industrial sulfur-containing flue gas is the flue gas from the roasting of sulfide ores. The sulfur-containing oxides in the flue gas are SO₂ gases. The alkaline solution used for the capture of SO₂ gases includes a 4 mol/L NaOH solution. The flow rates of the sulfur-containing flue gas are all 4 mL/s, and the introduction time is 10 min to obtain treatment solution, which contains sulfites.
S2. The waste PET plastics are hydrolyzed under alkaline conditions to obtain the PET hydrolysate containing ethylene glycol.

Among them, the waste PET plastic is 200-mesh waste PET powder, the alkaline solution for treating the waste PET plastic is a 6 mol/L NaOH solution, the reaction temperature is 70° C., the stirring speed is 200 rpm, the reaction time is 6 hours, and the solid-to-liquid ratio is 1:8.

The specific operation of pH adjustment treatment is as follows: after the waste PET plastics are hydrolyzed in an alkaline solution, the pH of the hydrolysate is adjusted to 2.9. After the precipitated TPA is separated by solid-liquid separation, an acidic hydrolysate containing ethylene glycol is obtained.
S3. An electrolyte is prepared by mixing the treatment solution and the PET hydrolysis solution, and then, the electrolyte is subjected to an electrolytic reaction, which converts ethylene glycol and sulfur-containing oxides therein into hydroxymethanesulfonate.

Among them, after mixing the treatment solution and the PET hydrolysate, further pH adjustment is required to prepare an acidic hydrolysate with a pH of 5.65 for the subsequent electrolytic reaction.

The electrolytic reaction adopts a three-electrode system, which consists of a working electrode, a counter electrode, and a reference electrode. The working electrode is cobalt oxide loaded on carbon fiber paper, the reference electrode is Ag/AgCl, and the counter electrode is a platinum mesh.

The preparation method of the working electrode for the electrolytic reaction is as follows:
1) Prepare the deposition solution: Prepare 20 mL of 0.06 M cobalt nitrate solution.
2) Chemical deposition: Immerse a 1 cm*1 cm carbon fiber paper in a cobalt nitrate solution, maintain the temperature at 50° C. in a constant-temperature water bath and stir for 24 hours to ensure that cobalt nitrate is fully adsorbed on the surface of the carbon fiber paper. Take out the impregnated carbon fiber paper and rinse it thoroughly with deionized water to remove the unadsorbed cobalt nitrate on the surface.
3) Drying and calcination: Place the carbon fiber paper loaded with cobalt nitrate in an oven and dry it at 60° C. to a constant weight. Then, transfer the dried carbon fiber paper to a muffle furnace and calcine it at 500° C. for 4 hours to decompose and convert cobalt nitrate into cobalt oxide. After the calcination is completed, take out the carbon fiber paper and dry it again in the oven at 60° C. to a constant weight to obtain cobalt oxide supported on carbon fiber paper.

The voltage of the electrolytic reaction is 1.3 V vs. Ag/AgCl. The electrolyte used contains 0.1 M K₂SO₄, 20 mM Na₂SO₃, and 200 mM ethylene glycol, and the reaction time is 260 min.

The yield of hydroxymethanesulfonate obtained was 0.21 mol cm-2 h-1, and the purity of hydroxymethanesulfonate was 78%.

### Example 6

This example provides the following method for the electrocatalytic co-treatment o industrial sulfur-containing flue gas and the conversion of PET waste plastics into hydroxymethanesulfonate, including:
S1. The industrial sulfur-containing flue gas, which contains sulfur-containing oxides, is passed into an alkaline solution to obtain a treatment solution.

Among them, the industrial sulfur-containing flue gas is the flue gas from the roasting of sulfide ores. The sulfur-containing oxides in the flue gas are SO₂ gas. The alkaline solution used for the capture of SO₂ gas includes a 2 mol/L NaOH solution. The flow rate of the sulfur-containing flue gas is 5 mL/s, and the introduction time is 30 min. The treatment solution is obtained, and the treatment solution contains sulfites.
S2. The waste PET plastics are hydrolyzed under alkaline conditions to obtain a PET hydrolysate containing ethylene glycol.

Among them, the waste PET plastic is 200-mesh waste PET powder. The alkaline solution for treating the waste PET plastic is a 4 mol/L NaOH solution. The reaction temperature is 90° C., the stirring speed is 400 rpm, the reaction time is 8 hours, and the solid-to-liquid ratio is 1:10.

The specific operation of pH adjustment treatment is as follows: after the waste PET plastics are hydrolyzed by an alkaline solution, the hydrolysis solution is adjusted to pH=2.8. After the precipitated TPA is separated by solid-liquid separation, an acidic hydrolysis solution containing ethylene glycol is obtained.
S3. An electrolyte is prepared by mixing the treatment solution and the PET hydrolysis solution, and then, the electrolyte is subjected to an electrolytic reaction, which converts ethylene glycol and sulfur-containing oxides therein into hydroxymethanesulfonate.

Among them, after mixing the treatment solution and the PET hydrolysis solution, further pH adjustment is required to obtain an acidic hydrolysis solution with a pH of 5.65 for the subsequent electrolytic reaction.

The electrolytic reaction adopts a three-electrode system, which consists of a working electrode, a counter electrode, and a reference electrode. The working electrode is palladium oxide loaded on carbon cloth, the reference electrode is Ag/AgCl, and the counter electrode is a platinum mesh.

The preparation method of the working electrode for the electrolytic reaction is as follows:
1) Prepare the deposition solution: Dissolve 0.01 g of potassium permanganate, 0.1 g of palladium sulfate, and 0.02 g of potassium persulfate in 20 mL of deionized water, and stir magnetically until completely dissolved. Adjust the pH of the solution to 8-11.
2) Chemical deposition: Immerse a 1 cm×1 cm carbon cloth into the deposition solution to ensure complete immersion. Place the deposition solution on a magnetic stirrer and stir at an appropriate speed while controlling the reaction temperature at 75° C. After reacting for 6 h, take out the carbon cloth and rinse it with deionized water to remove the unreacted substances attached to the surface.
3) Drying and calcination: Place the washed carbon cloth in an oven and dry it at 60° C. until a constant weight is achieved. Then, put it into a tube furnace and calcinate it at 300° C. for 2 h, followed by natural cooling. Subsequently, place it in the tube furnace again and calcinate it at 500° C. for 3 h to remove impurities, and then take out the palladium oxide loaded on the carbon cloth after natural cooling.

The voltage of the electrolytic reaction was 1.35 V vs. Ag/AgCl. The electrolyte used contained 0.1 M K₂SO₄, 20 mM Na₂SO₃, and 200 mM ethylene glycol, and the reaction time was 280 min.

Analysis of the solution after the electrolytic reaction was completed showed that the yield of hydroxymethanesulfonate was 0.25 mol cm⁻² h⁻¹, and the purity of hydroxymethanesulfonate was 76%.

### Comparative Example 1

Different from Example 1, the working electrode used in step S3 is changed to Au/Ni(OH)₂ supported on nickel foam.

The preparation method of the working electrode for the electrolytic reaction is as follows:

First, immerse a 1 cm×1 cm nickel foam electrode in a mixed solution containing 0.05 mM AuCl₃ and 0.5 M NaCl, and let it stand at 25° C. for 6 hours. Then, wash the previous product with ultrapure water and ethanol. Finally, anneal the nickel foam in an oven at 200° C. for 2 hours to prepare the Au/Ni(OH)₂ composite catalyst supported on nickel foam. Here, Ni(OH)₂ is a porous material layer on the surface of the nickel foam electrode, which serves as a carrier with a layer of metallic Au covering its surface.

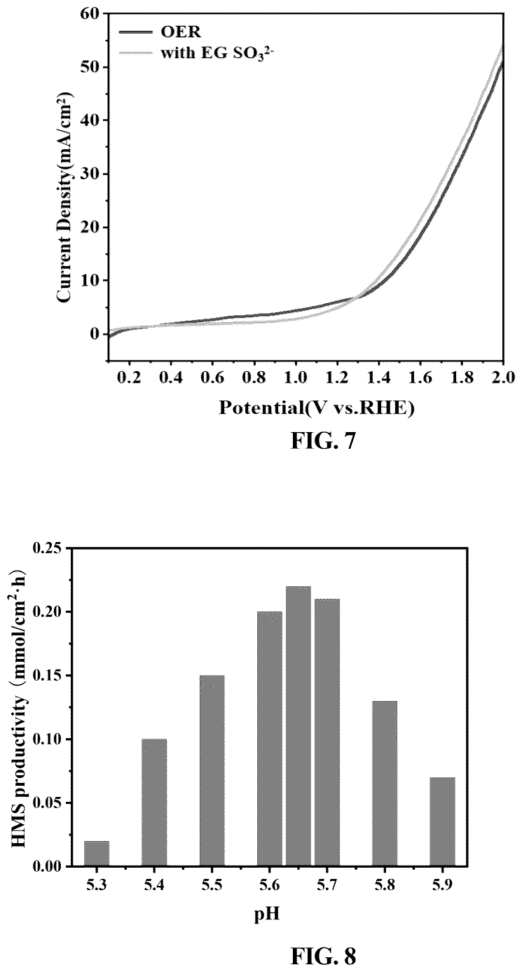

The electrolyte used contains 0.1 M K₂SO₄, 20 mM Na₂SO₃, and 200 mM ethylene glycol. The linear sweep voltammetry (LSV) curves were collected. The test results marked as EG+SO₃ are shown in FIG. 7, while the curve marked as OER (oxygen evolution reaction) in FIG. 7 serves as a reference. It was obtained by conducting the LSV test under the same electrode conditions in this comparative example, but the electrolyte did not contain ethylene glycol and only contained the same concentration of sulfite. It can be seen that the working electrode in this comparative example cannot catalyze the electrolysis reaction to obtain hydroxymethanesulfonate. Therefore, it can be concluded that the metal hydroxides or oxides loaded on the working electrode proposed in this invention can effectively achieve the electrocatalytic synergistic treatment of industrial sulfur-containing flue gas and the conversion of PET waste plastics into hydroxymethanesulfonate.

### Comparative Example 2

Different from Example 1, the pH values of the electrolyte used in the electrolytic reaction in step S3 are different, and multiple groups of comparative experiments are set up. The pH values are 5.3, 5.4, 5.5, 5.6, 5.7, 5.8, and 5.9 respectively.

The yields of hydroxymethanesulfonate under different pH conditions are shown in FIG. 8. By comparing different pH conditions and testing the yields of hydroxymethanesulfonate, it can be seen that when the pH of the electrolyte is between 5.6 and 5.7, a high yield of hydroxymethanesulfonate is obtained. However, when the pH is lower or higher than this range of 5.6-5.7, the catalytic efficiency of the catalyst decreases significantly. Therefore, the optimal electrolysis reaction condition of the present invention is a weakly acidic condition with a pH of 5.6-5.7.

The above embodiments represent preferred implementation modes of the present invention. However, the implementation of the present invention is not limited to these embodiments. Any other changes, modifications, substitutions, combinations, or simplifications made without departing from the spirit and principles of the present invention should be regarded as equivalent replacement methods and are all included in the protection scope of the present invention.

What is claimed is:

1. A method for electrocatalytically and synergistically treating industrial sulfur-containing flue gas and converting PET waste plastics into hydroxymethanesulfonate, comprising the following steps:
S1. Pass industrial sulfur-containing flue gas, which contains sulfur-containing oxides, into an alkaline solution to obtain a treatment solution,
S2. Waste PET plastics are hydrolyzed in an alkaline solution to obtain PET hydrolysate containing ethylene glycol,
S3. An electrolyte is prepared by mixing the treatment solution and the PET hydrolysis solution, and then, the electrolyte is subjected to an electrolytic reaction, which converts ethylene glycol and sulfur-containing oxides therein into hydroxymethanesulfonate;
The electrode system in step S3 consisting of a working electrode, a counter electrode, and a reference electrode, the working electrode is a metal oxide or hydroxide loaded on a carbon fiber paper or a carbon cloth, the pH of the electrolyte is 5.6-5.7, and the metal in the working electrode including one or more of cobalt, nickel, manganese, copper, or palladium.

2. The method for electrocatalytically and synergistically treating industrial sulfur-containing flue gas and converting PET waste plastics into hydroxymethanesulfonate according to claim 1, wherein the industrial sulfur-containing flue gas in step S1 contains SO₂ gas, the alkaline solution is a 0.1-4 mol/L NaOH or KOH solution, the flow rate of the sulfur-containing flue gas is 2-5 mL/s, and the introduction time is 10-60 min; the SO₂ gas is converted into sulfite.

3. The method for electrocatalytically and synergistically treating industrial sulfur-containing flue gas and converting PET waste plastics into hydroxymethanesulfonate according to claim 1, wherein the hydrolysis conditions in step S2 are as follows: a 2-6 mol/L NaOH or KOH solution, the reaction temperature is 50-90° C., the stirring speed is 100-500 rpm, the reaction time is 6-24 hours, and the solid-to-liquid ratio is 1:5-1:20 g/mL.

4. The method for electrocatalytically and synergistically treating industrial sulfur-containing flue gas and converting PET waste plastics into hydroxymethanesulfonate according to claim 1, wherein the waste PET plastics in step S2 are one or more of waste PET powder, waste PET plastic blocks, or processed finished products of waste PET plastics.

5. The method for electrocatalytically and synergistically treating industrial sulfur-containing flue gas and converting PET waste plastics into hydroxymethanesulfonate according to claim 1, wherein after the waste PET plastics in step S2 are hydrolyzed by an alkaline solution, the pH of the hydrolysate is adjusted to 2.8-3.0, and then a precipitated TPA is separated by solid-liquid separation from the hydrolysate containing ethylene glycol.

6. The method for electrocatalytic synergistic treatment of industrial sulfur-containing flue gas and conversion of PET waste plastics into hydroxymethanesulfonate according to claim 1, wherein the reference electrode is Ag/AgCl, and the counter electrode is a platinum mesh.

7. The method for electrocatalytically and synergistically treating industrial sulfur-containing flue gas and converting PET waste plastics into hydroxymethanesulfonate according to claim 1, wherein the electrolysis conditions in step S3 are constant voltage conditions, and the voltage is 1.20-1.35 V, which is the voltage relative to the reference electrode Ag/AgCl, at room temperature.

8. A method for electrocatalytically and synergistically treating industrial sulfur-containing flue gas and converting PET waste plastics into hydroxymethanesulfonate according to claim 1, wherein the electrolyte in step S3 includes 0.01-0.1 M sulfite and 0.1-1 M ethylene glycol.
